(19) United States
(12) Patent Application Publication
(10) Pub. No.: US 2005/0116836 A1
(43) Pub. Date: Jun. 2, 2005

(54) Method and apparatus for monitoring power consumption on power distribution circuits for centralized analysis

(75) Inventors: David Gareth Perry, Ottawa (CA); Robert P. Brennan, Pakenham (CA)

Correspondence Address: OGILVY RENAULT, 1981 MCGILL COLLEGE AVENUE, SUITE 1600, MONTREAL, QC, H3A2Y3, CA

(73) Assignee: TRIACTA POWER TECHNOLOGIES INC., Almonte (CA)

(21) Appl. No.: 10/724,145

(22) Filed: Dec. 1, 2003

(51) Int. Cl. G08C 15/06; G08B 23/00

(52) U.S. Cl. 340/870.02

(57) ABSTRACT

A method, apparatus, and system for providing a power monitoring service to an electric power consumer at a power consumer site involves providing a monitoring unit at the power consumer site with connections to probes on individual power distribution circuits emanating from a power distribution and control panel of the consumer site. The monitoring unit measures a power consumption of each of the power distribution circuits using the probes, and communicates power consumption data related to the respective power distribution circuits to a power monitoring server that collects and analyzes the power consumption data. The power monitoring server has a circuit description table that identifies each of the power distribution circuits to permit detailed billing to the power consumer. The monitoring server also uses per-circuit information relating to many power consumers to compute at least one aggregate power consumption profile.

### CROSS-REFERENCE TO RELATED APPLICATIONS

This is the first application filed for the present invention.

### MICROFICHE APPENDIX

Not Applicable.

### TECHNICAL FIELD

The invention generally relates to a method and system for monitoring electrical power consumption, and in particular, it relates to a method and system for monitoring power consumption on power distribution circuits at a power consumer site, and collecting and analyzing the power consumption at a remote data processing facility.

### BACKGROUND OF THE INVENTION

Monitoring electricity consumption at residential, commercial and industrial sites for billing purposes is well known. Certain power utility companies have systems for doing this, some of which are partially or wholly automated (e.g. U.S. Pat. Nos. 5,014,213, 6,437,692, and 6,545,482), while other power utility companies still inspect consumer electricity meters using meter-reading personnel. There are also other reasons for monitoring power consumption. For example, in a multi-dwelling facility where the power utility company provides a single metered supply, division of power consumption charges based on use requires an internal tracking system.

Many consumers are also motivated by peak hour usage charges, reduced consumption incentives, and other billing schemes provided by power utility companies, to monitor consumption and to reduce the amount of the power utility bill. Yet other power consumers want to know how much power each distribution circuit is consuming so that efficiency and utilization of electric appliances and fixtures can be monitored.

Systems for monitoring and controlling power consumption of individual appliances are known. For example, U.S. Pat. No. 6,552,525, which issued to Bessler on Apr. 22, 2003 teaches an apparatus and method for collecting and transmitting appliance power consumption information to an appliance service provider server over the Internet. The appliance service provider server and a customer both have control over the appliances. The appliance service reduces costs of electricity by scheduling use of the appliances. The schedule can be remotely enforced by the appliance service provider. The cost savings that may be realized by scheduling such power consuming services are the primary objective of this service, however, a secondary advantage related to detecting wear on the appliances, and providing preventative maintenance is also provided. Furthermore predicted demand of the appliance's power consumption may be used for scheduling purposes.

The interconnection of smart appliances to a computer is well known in the art. Standards are being developed to facilitate an industry in this area. It is known to connect intelligent appliances using radio-frequency communications, as well as powerline and telephone line home networking systems.

For example U.S. Pat. 6,061,604, which issued to Ross et al. on May 9, 2000, describes a system for monitoring and controlling appliances within a multi-dwelling residence. The system provides for communications between appliance interface modules that control and monitor states of the corresponding appliances, etc. The advantages of monitoring power and other utility consumption to determine a cost of use at each dwelling; and to determine how efficiently appliances are operating, how frequently appliances' are being used, excessive consumption, etc. on a per dwelling basis, are of identified value. The draw of electricity (or gas) of an appliance may indicate whether the appliance is functioning properly, particularly in comparison with consumption of similar appliances in similar dwelling units.

From the power utility company's point of view, per-appliance consumption information provides valuable information regarding consumption, as is suggested by Bessler. As is noted by Bessler, the consumption of appliances is desired, however substantial difficulties are encountered when trying to provide enough consistent information regarding power consumption in residential, commercial, and industrial sites to provide profiles of use to power producers, distributors, and other parties (regulating authorities, parties interested in power futures, etc) by monitoring selected appliances for power consumption data collection. For example, as noted above, seasonally-adjusted power consumption profiles are useful for predicting future consumption, which is important when utilities enter into long-term contracts for electricity consumption. It should further be noted in this regard that U.S. Pat. No. 6,519,509, which issued to Nierlich et al. on Feb. 11, 2003 teaches using meter readings sent to centralized data storage and analysis system for monitoring and control of power consumption, and to provide an aggregated power consumption statistic. As will be appreciated, the granularity of power consumption tracked by electricity consumption meters, does not provide a statistic that is useful for many purposes. Information related to individual circuits is required to provide a profile that is useful to most power consumers.

The cost of retrofitting appliances with controllers and sensors (as per Bessler), appliance interface modules (according to Ross et al.), or of provisioning an intelligent utility unit, other smart appliance system, or smart-home-type system is substantial, and for a majority of home owners, providing substantially complete information about power consumption is not economically viable. Smart appliances are also expensive, and it is generally not economic to retrofit or replace appliances to save a fraction of power utility bills. Furthermore, the expense associated with interconnecting appliance controllers to each other and to a computer adds substantial cost and complexity to the system. Equipping a computer with software for processing the appliance state and power consumption information may not present a very significant processing load, but does require that the computer remain permanently on-line, and access to the Internet to be initiated and sustained for exchanging the information with the server as required.

It is also known that these methods only apply to those appliances that are connected to controllers, and therefore do not provide a complete accounting of power consumption at a power consumption site. While it is known that the cost of the controllers and sensors can be reduced by connecting electromagnetic pickup devices on individual power distribution circuits of the building's power distribution and control box, as is taught in U.S. Pat. No. 5,880,677, which issued to Lestician on Mar. 8, 1999, and connection to each circuit permits complete accounting for electricity consumption, this system still requires an interface for connection to a personal computer, or a computing device that is adapted to display data to the power consumer. Besides, the information regarding consumption of power is often not very useful without a basis of comparison. The accumulation of data from numerous consumers in comparable conditions is much more relevant for deciding on how power-efficient an appliance is, where most substantial power savings can be realized, etc.

There are a number of patents that have been issued in this field of technology that teach appliance-based power consumption monitoring, load shedding (and other consumption suppression systems), and appliance control. Some of these teach monitoring both total power consumption and appliance control/monitoring (e.g. a multi-facility industrial application U.S. Pat. No. 6,633,823, which issued to Bartone et al.; a multi-dwelling unit application taught in U.S. Pat. No. 6,061,604; and an invasive appliance power control application taught in U.S. Pat. No. 5,528,507). However the ability to identify use of several power consuming devices on power distribution circuits as opposed to aggregate consumption demand, improves detection as total consumption demand monitoring may mask significant differences in power consumption on respective circuits.

There therefore remains a need for an affordable method of centralized monitoring of power consumption by each power distribution circuit of a power consumer site.

### SUMMARY OF THE INVENTION

It therefore is an object of the invention to provide a method and system for monitoring power consumption by individual power distribution circuits of a power consumer site.

It is also an object of the invention to provide a method and apparatus for collecting power consumption data for each power distribution circuit of a power consumer site, in order to obtain power consumption profiles that indicate power consumption on a per-appliance and/or per-circuit basis. This information is useful for governments, regulatory agencies, power utility companies, power producers, power distributors, power brokers, analysts, appliance manufacturers, and consumers.

The invention therefore provides a method for providing a power monitoring service. The method comprises providing a monitoring unit at a power consumer site with connections to probes on individual power distribution circuits emanating from a power distribution and control panel of the consumer site. An identification of at least one electrical load on each power distribution circuit is entered into a circuit description table. A power consumption of each of the power distribution circuits is measured using the respective probes, and power consumption data related to the respective power distribution circuits is communicated to a power monitoring server that collects the power consumption data. The power consumption data is analyzed to provide useful information to interested parties.

The parties interested in the analyzed power consumption data may include any one of the power consumer, a power utility, a power analyst, a power broker and a government agency. A world wide web interface is provided to permit the interested parties to access the power consumption information in accordance with a subscription agreement between the power monitoring service and the interested party. Communicating the power consumption data comprises: storing a measured power consumption of each of the power distribution circuits accumulated during a measurement interval phase; and transmitting the stored power consumption data to the power monitor server during a data transmission phase.

The power consumption information may be used to compute a power consumption profile of the power consumer site. The power consumption information and the circuit description table associated with the power consumption sites may also be used to compute an aggregate power consumption profile of at least one appliance. The power consumption information associated with the appliance and a power distribution circuit with the aggregate power consumption profile may be used to identify actual power consumption differences between the appliance and a mean of power consumption of similar monitored appliances. The information related to power consumption of one of the appliances over an interval of time, and the aggregate power consumption profile associated with the appliance, may also be used to identify a fault in the appliance. The information related to power consumption of the power distribution circuits over an interval of time may also be provided to a power utility company, to permit the power utility company to issue a per-circuit itemized bill to the electrical power consumer.

The information related to power consumption of the power distribution circuits of a plurality of the power consumer sites, may also be used to permit the power utility company that provides electricity to the consumer site, to perform prospective studies.

The invention further provides a system for monitoring power consumption information relating to individual power distribution circuits of a consumer site. The system comprises a plurality of probes connected to respective ones of the power distribution circuits, each power distribution circuit being associated with a corresponding circuit description table that identifies at least one electrical load on the power distribution circuit. A monitoring unit is connected to the probes, the monitoring unit including at least one processor for receiving power consumption parameter values measured by the probes, a memory for storing the values, and a communications link for transmitting the power consumption information to a communications network. Monitoring service equipment is connected to the communications network for receiving the power consumption parameter values, analyzing the power consumption parameter values to obtain power consumption information and making the power consumption information available to interested parties.

Each of the at least one processors may comprise a digital signal processor (DSP) for sampling the measured power consumption parameter values output by the current probes. Each DSP samples each of a plurality of the probes in a cycle, so that a number of DSPs required is less than the number of power distribution circuits. The monitoring unit further comprises an interface for transmitting commands to a controller of at least one power consuming device, the interface and controller permitting the control of the device.

The invention further provides a system for retrieving power consumption information related to individual power distribution circuits of a power consumer site. The system comprises a plurality of probes connected to respective ones of the power distribution circuits, each power distribution circuit being associated with a corresponding circuit description table that identifies at least one electrical load on the power distribution circuit. A monitoring unit is connected to the probes, the monitoring unit including at least one processor for receiving power consumption parameter values measured by the probes, a memory for storing the samples, and a communications link for communicating power consumption information to a remote centralized monitoring service. A monitoring service server is adapted to receive and store the power consumption information, and analyze the power consumption information to compute a power consumption profile of the individual power distribution circuits. The monitoring service server performs an analysis of power consumption at the power consumer site using the power consumption profile. The monitoring service server comprises a database for storing an aggregate power consumption profile computed using power consumption profiles and circuit description tables of other power consumers. The monitoring service server may further comprise a world wide web site for selectively displaying the power consumption profiles and aggregate power consumption profiles. The monitoring service may monitor consumption information to detect anomalies respecting the power consumption of appliances connected to the monitored power distribution circuits. The monitoring unit may also comprise an interface for transmitting commands from the monitoring service server to a controller of at least one power consumer site device, the interface and controller permitting the monitoring service server to instruct the controller to effect control of the device.

A cost of monitoring, collecting and analyzing data is reduced by providing centralized processing of power consumption data for numerous consumers. The analyzed data can be accessed by authenticated users of the Internet via a secure connection from a standard browser. Cost is also reduced by subsiding the cost of monitoring and analysis by offering access to selected portions of the analyzed data on a fee basis to interested parties, in particular, power producers, power utility companies, power brokers, analysts, comparative advertisers, etc.

### BRIEF DESCRIPTION OF THE DRAWINGS

Further features and advantages of the present invention will become apparent from the following detailed description, taken in combination with the appended drawings, in which:

FIG. 1 schematically illustrates a system for monitoring power consumption on a per-circuit basis, and forwarding the power consumption information for analysis;

FIG. 2 schematically illustrates a system for monitoring and controlling power consumption on a per-circuit basis, and forwarding the power consumption information to a power utility, to permit itemized billing;

FIG. 3 is a flow chart illustrating principal steps involved in installing and setting up the monitoring system at a power consumer site;

FIG. 4 is a flow chart illustrating principal steps involved in processing the power consumption information at the power consumer site;

FIG. 5 is a flow chart illustrating principal steps involved in processing the power consumption information at a monitoring service server;

FIG. 6 is a flow chart illustrating principal steps involved in a power consumer accessing a world wide web site of the monitoring service, in accordance with the embodiment shown in FIG. 1; and

FIG. 7 is a schematic illustration of a per-circuit itemized power utility bill issued to the power consumer in accordance with the embodiment shown in FIG. 2.

It should be noted that throughout the appended drawings, like features are identified by like reference numerals.

### DETAILED DESCRIPTION OF THE PREFERRED EMBODIMENT

The invention provides a method, apparatus, and system for monitoring power consumption at a power consumer site. The system provides a complete profile of the consumption of power on a per-circuit basis, without connecting sensors to each circuit outlet and appliance. The apparatus connects to each power distribution circuit emanating from a power distribution and control box where a power main of the power consumer site is divided. The per-circuit power consumption information permits usage and consumer profiles to be computed, and can be aggregated with profiles of other similar power consumer sites to provide statistics useful to the consumer as well as many other groups. For example, using a history of profiles, seasonally adjusted mean profiles can be computed and used for many prospective studies. For example, those profiles are valuable to power utility companies who can use the information to contract electricity supplies in advance, thereby reducing overall cost and dependence on spot-market power purchases.

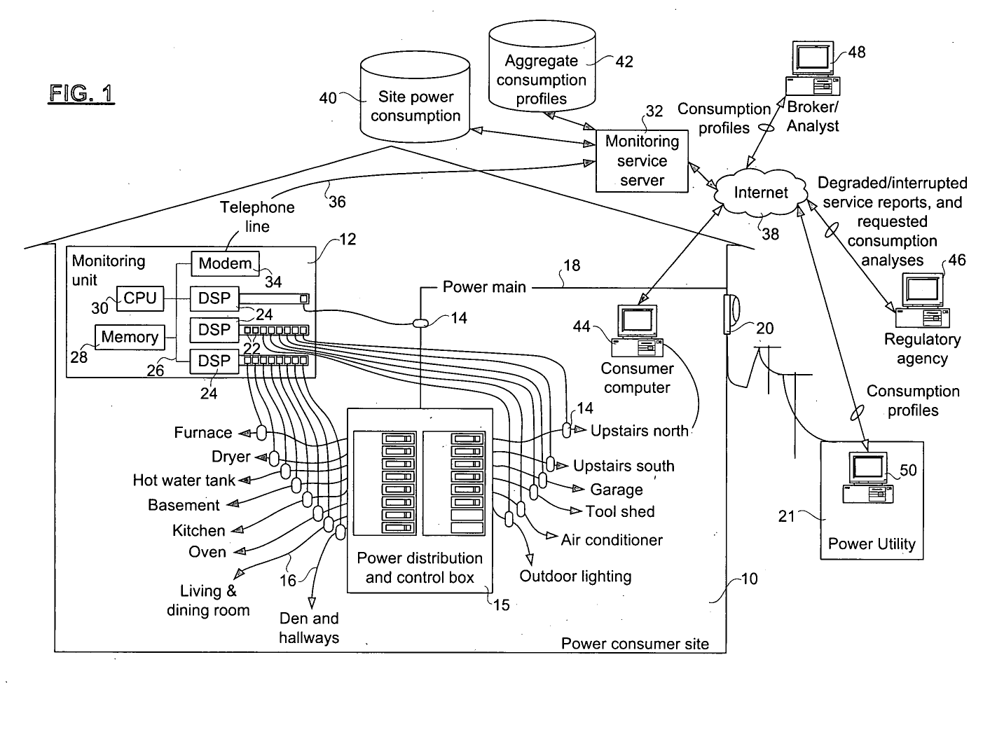

FIG. 1 schematically illustrates a power consumer site 10 equipped with a monitoring unit 12 that is coupled to a plurality of probes 14 (only two of the 15 probes 14 are labeled to facilitate illustration). The probes 14 may be clamp-on current probes, which are commercially available, or other devices for measuring power consumption. When installed as shown, each of the probes 14 is coupled to a respective power distribution circuit 16, except a probe 14 that is coupled to a power main 18. The power main 18 supplies power to a power distribution and control box 15, commonly referred to as a “breaker box”, to which the power distribution circuits 16 are connected. The power main 18 may be connected to a power service meter 20, which is in electrical connection with a power supply grid that is controlled by a power utility company 21.

Each of the power distribution circuits 16 supplies power to one or more appliances and power consuming devices. In accordance with the present invention, each of the power distribution circuits 16 is associated with these appliances and power consuming devices by a circuit description table. The itemization of the power consuming devices may have any specified threshold of detail. While the power distribution circuits 16 illustrated identify a chief appliance on each of the circuits, or an area in the consumption site 10, further detail may be included to identify particular outlets or embedded power consuming devices such as exhaust fans, ceiling fans, lighting fixtures, etc. The particular power consuming devices connected to respective outlets (particularly those that are not prone to being relocated), may also be associated with the respective power distribution circuits 16.

There are two criteria relevant to the level of description that may be desired in the circuit description table. In accordance with a first criterion, a power consumer who pays for the supply of power to the consumer site 10 will receive a profile of per-circuit consumption information, and this information can only be as detailed as the information available to a monitoring service provider. Whatever the level of description desired by the power consumer for billing purposes, in order for the monitoring service to identify indications of developing failures in the power consuming devices or the circuits themselves, a finer resolution may be required in the circuit description table. The second criterion is that for the information compiled at the monitoring service to be ideally useful, a systematic association of one or more loads (appliance and other power consuming devices, fixtures, etc) characteristic of the respective circuits, may be preferred. This further simplifies completion of the circuit description table.

The monitoring unit 12 provides a plurality of ports 22 for connection with respective probes 14. The ports 22 are connected to digital signal processors 24 (DSPs) in the following manner: the probe 14 connected to the power main 18 is connected to a unique port 22, to which a dedicated DSP 24 is connected; the other DSPs 24 are each connected to eight ports 22. The DSPs 24 are commercially available, standards-accredited metering devices. In the configuration shown, the DSP 24 that is dedicated to the power main 18 is equivalent to the power service meter 20 and can be used to replace the power service meter 20, which becomes redundant. The other two DSPs 24, however, apply a time-shared monitoring to each of up to eight power distribution circuits 16 via eight respective probes 14, and are consequently not sufficiently precise for standards purposes, but provide more than adequate measurements for monitoring proposes. In accordance with the time-shared monitoring, the DSPs 24 may receive and digitize a sample from each of the eight power distribution circuits, in a cycle. Accordingly, the dedicated DSP 24 measures kwh (kilo watt hours) where as the other two DSPs measure kw, in accordance with the embodiment shown. However other power consumer parameters can be measured, in other embodiments. It will be evident to those skilled in the art that with time-shared access to the respective circuits, fewer DSPs are required to monitor the power distribution circuits, and monitoring unit 12 cost is reduced.

The DSPs 24 are interconnected via a bus 26 to non-volatile memory 28, and a central processing unit 30 (CPU). The CPU 30 controls operation of the respective DSPs 24, as required, and effects the storage and retrieval of measurements processed by the DSPs 24. The measurements are samples of electric current, or a like power consumption parameter. The CPU 30 is further adapted to effect communication of data stored in the memory 28 to a server 32 of the monitoring service, using a modem 34. It will be recognized by those of skill in the art that many other communications systems can be used for conveying this information instead of a telephone communications modem. The modem 34, in accordance with the preferred embodiment is a telephone modem connected to a telephone line 36 of the power consumption site 10. In a manner well known in the art data transmitted by a telephone modem is sent over a telephone network to the monitoring service.

In order to provide the monitoring and notification services to the power consumer, and other information services to other interested parties, the monitoring service provider maintains the monitoring service server 32 for receiving the per-circuit power consumption information from a plurality of power consumer sites like consumer site 10. The monitoring service server 32 analyzes and stores the received per-circuit power consumption information. In accordance with the present embodiment, the monitoring service server 32 maintains two types of information; information that is particular to the power consumer sites maintained in a site power consumption database 40, and aggregate information that is associated with one or more classes of power consumer sites and maintained in an aggregate power consumption profiles database 42. The classes may be defined geographically, by a size of the consumption site, by a number of occupants, by a residential, commercial, or industrial type code, etc. Methods for statistically aggregating information like the power consumption information, are known in the art.

The consumer site power consumption information may be maintained in confidence, or an agreement extending between the power consumer, monitoring service, and the power utility company 21 or other interested party may permit particular information to be distributed by the monitoring service. In general, mean consumption trends on an appliance or system basis is preferred to detailed consumer information, and privacy concerns may prohibit the distribution of individual consumer information.

In accordance with the illustrated embodiment, a preferred means of communicating with the monitoring service is using a web service based on the Internet 38. Of course other methods are available for accessing content of the aggregate power consumption profiles database 42, and requests for reports produced from this data may be made in other ways.

Internet sites are known for providing registered users with an opportunity to log in for secure access to data. In accordance with the illustrated embodiment, a consumer computer 44 is provided. While the consumer computer 44 is shown as a personal computer that is connected to one of the power distribution circuits 16, it will be understood that a large array of devices can be used in this capacity, some of which are wireless, and others of which are tethered, and that a considerable advantage of the Internet embodiment is that the power consumer can access the power consumption information from any device with a suitable web browser application. A method for accessing the monitoring service server 32 is described below in more detail with reference to FIG. 6.

The monitoring service server 32 is further adapted to provide consumer profile information in a predefined format to the power utility company 21 (or power producers, resellers, power grid owners and maintainers, and other parties involved in power supply, regulation, production or distribution), regulatory agencies 46 or other government agencies, as well as brokers and analysts 48 who are interested in energy futures and trends in activities in related markets. The information is provided on a subscription basis in accordance with controls required to comply with privacy of information regulations, for example.

The power utility company 21 have a contractual agreement with the monitoring service to provide consumption profiles of segments of the power consumer service area. For example, this information can be used by an analysis workstation 50 to determine strategies for reducing peak power consumption that are likely to be effective.

The broker/analyst 48 may request information relating to impact on power consumption of particular events, and conditions.

Regulatory agencies 46 can request reports relating to effects of black-outs or brown-outs, etc. on power consumers, and may further request consumption analyses that indicate the trends in power consumption and help identify relevance and need for changes in regulations. The prospective trends in power consumption may further be useful for other reasons by other governmental agencies.

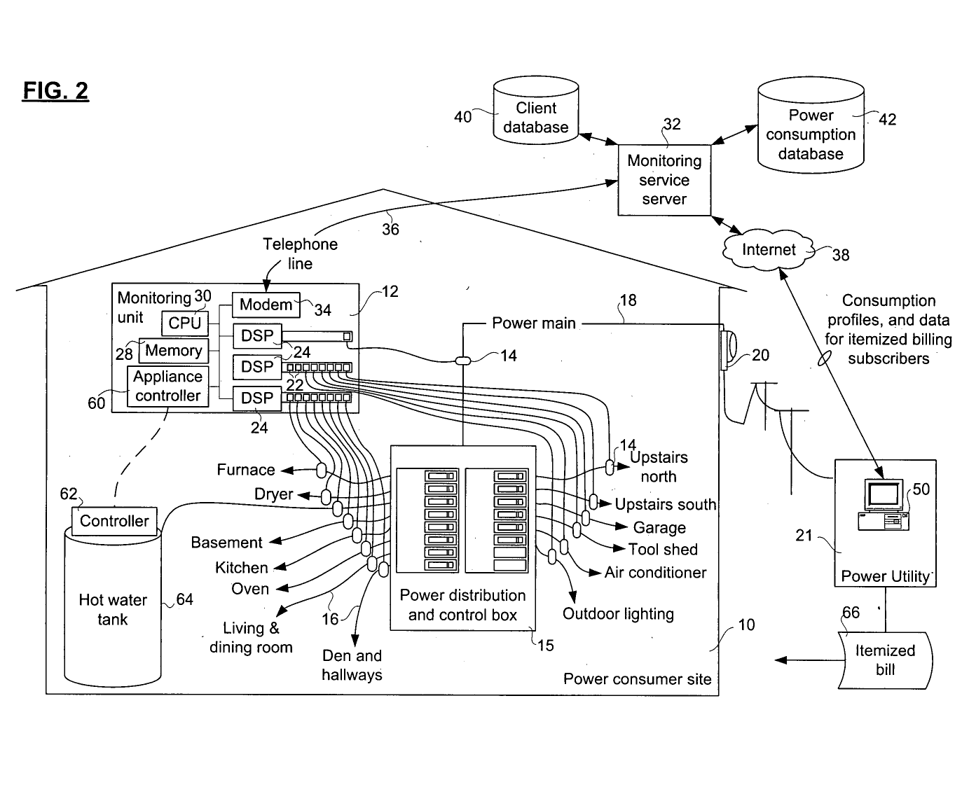

FIG. 2 schematically illustrates an alternate embodiment of the system shown in FIG. 1. While numerous features of the embodiments have remained the same in form and operation and are consequently identified by like reference numerals, and are not redundantly described, several independent differences between these two embodiments are shown. The monitoring unit 12 shown in FIG. 2 includes an appliance control interface 60, communicatively coupled to an appliance controller 62, which, in the illustrated embodiment, is connected to a hot water tank 64 that is powered by electricity.

The controller 62 and the appliance control interface 60 provide the monitoring service server 32 with control over functions of the hot water tank 64 for the purposes of controlling power consumption. As will be appreciated by those skilled in the art, the ability to reduce the cost of power consumed may be a desirable aspect of the service provided by the monitoring service. It will further be appreciated that many ways to communicatively connect devices like the appliance control interface 60 with the controller 62 of a power consuming device are known and can be used. One embodiment involves powerline networking, although home telephone networking, radio and other electromagnetic carrier communications systems, or wireline communications systems can be used. Any number of power consuming devices may be controlled in this manner from the monitoring service server 32. The CPU 30 is preferably provisioned with program instructions for receiving commands from the monitoring service server 32, and forwarding them to the appliance control interface 60.

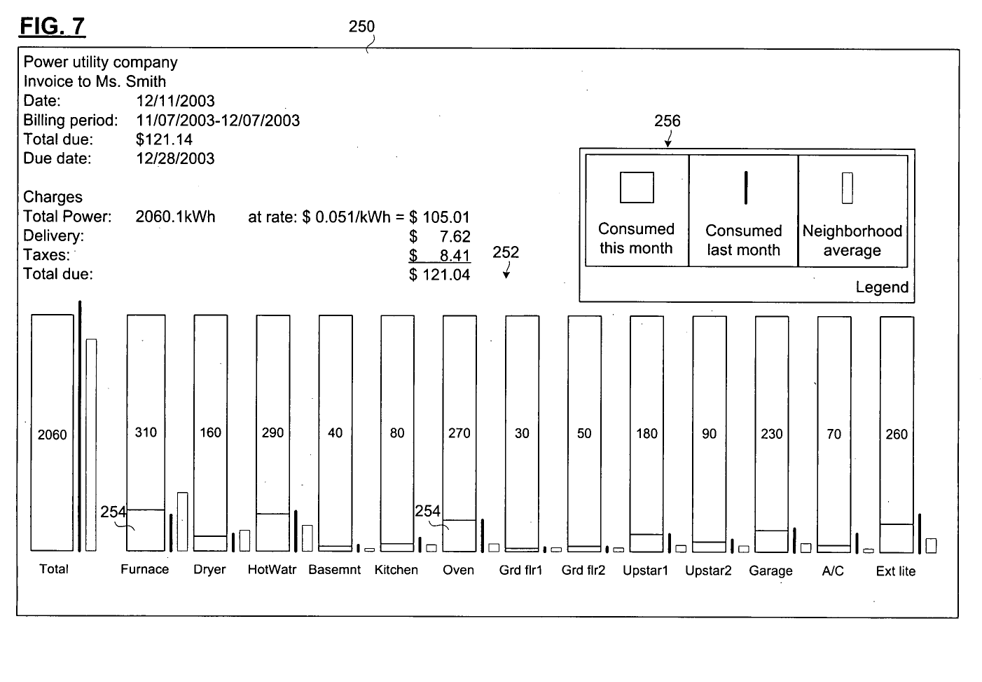

In accordance with the embodiment shown in FIG. 2, no consumer computer is involved in accessing the power consumption information, but rather the power utility company receives the client's power consumption information from the monitoring service server 32, and assembles a bill that is itemized on a per-circuit basis. An example of an itemized bill is schematically illustrated in FIG. 7. Access to the power consumption information can be provided by itemized bills and/or via the Internet, depending on the needs of each power consumer.

The power utility company 21 preferably receives both the aggregate power consumption profiles and the power consumption information for power consumers who subscribe to an itemized billing service from the monitoring service server 32 via the Internet using encrypted messaging. The analysis workstation 50 sends the power consumption information of the itemized billing subscribers to an automated billing system for handling the itemized billing information. The automated billing system issues the itemized bill 66 to the power consumer.

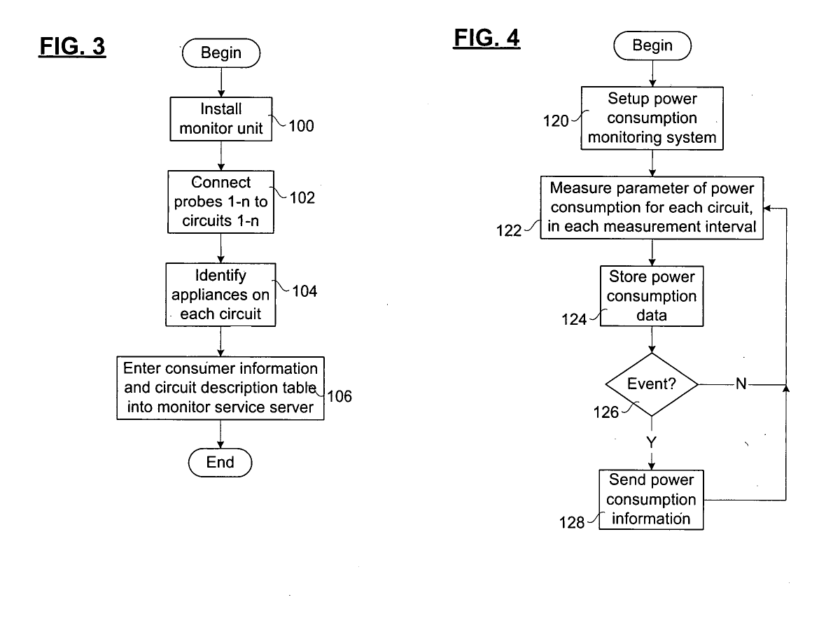

FIG. 3 is a flow chart illustrating a process for installing and setting up the monitoring unit 12 in accordance with the embodiment of the invention schematically shown in FIG. 1. The process begins when a representative of the monitoring service installs the monitoring unit (step 100) at the power consumer site 10, near the power distribution and control box 15. The representative connects probes to corresponding circuits of the power distribution and control box 15 in accordance with an agreement with the power consumer (step 102). A list of appliances and other power consuming devices is preferably made in order to permit completion of a circuit description table for the monitored power distribution circuits 16.

As described above, it is generally preferred to provide as complete an itemization of the appliances devices on each monitored circuit as is possible. A listing of the make, model and year of appliances can further be useful, particularly for identifying expected consumption, expected operating loads, etc. It is useful for statistical purposes to adopt a standardized approach to the identification of the appliances and other power consuming devices, accordingly only one interface for entering the items in the circuit description table is preferably used (step 106). This information may be entered by the power consumer, but is preferably entered by the monitoring service representative. When the consumer information and the circuit description table have been saved in the monitoring service database(s), the installation and set up of the monitoring system is complete. It should be noted that this setup process is far simpler, faster and less expensive than existing monitoring systems.

FIG. 4 schematically illustrates a method for monitoring power consumption on a per-circuit basis in accordance with either the first or second embodiment of the invention. The monitoring method begins with setup (step 120), which may be performed using the process shown in FIG. 3, for example. Once the system is set up and installed, a parameter of power consumption is measured at predefined measurement intervals (preferably by sampling an analog value of the parameter detected by the corresponding probe 14 (step 122). The measurement is then stored digitally at the monitoring unit 12 (step 124). The steps of measuring and storing the values continues until an event is detected in step 126. The event may be occupation of a predetermined fraction of the memory available at the monitoring unit 12, a request for data being received from the monitoring service server 32, or a scheduled transmission timer has expired, for example. Once the event is detected (in step 126) a data transmission phase begins, wherein the monitoring unit 12 issues power consumption information regarding each of the respective power distribution circuits to the monitoring service server 32 using the modem 34.

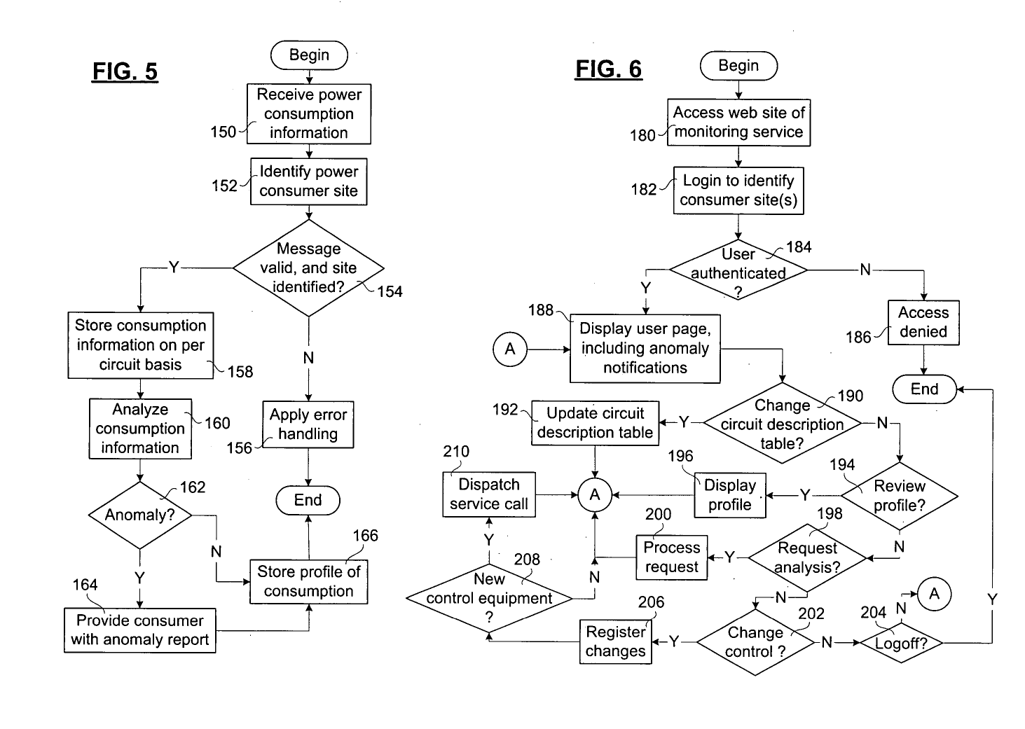

FIG. 5 illustrates principal steps involved in processing the power consumption information at the monitoring service server 32. In step 150 the power consumption information is received. The monitoring service server 32 uses messages that convey the power consumption information to identify the power consumer site 10 (step 152). If one or more of the messages containing the power consumption information is invalid, or the power consumer site 10 is not identified (as determined in step 154) the monitoring service server 32 applies error handling procedures (step 156). Otherwise, in step 158, the monitoring service server 32 stores the per-circuit power consumption information related to the identified consumer site 10. The stored power consumption information is analyzed by the monitoring service using known statistical methods. The analysis may involve computing mean power consumption values for similar power consuming devices and appliances identified in the circuit description table, or searching for known indicators of failure or sub-optimal operation of the appliances or power consuming devices on a particular circuit. Power consumption of each circuit may also be examined to determine if an anomaly exists (step 162). For example, if, instead of comparing a current power consumption of an appliance with the power consuming history of the appliance, a comparison is made with an aggregate power consumption profile computed by analyzing similar power consuming devices at other sites, any anomaly may indicate that power savings can be realized by repairing or replacing the appliance. If an anomaly is detected, the power consumer is notified (step 164). This notification may be provided by electronic mail, or other electronic messaging, telephone, or by publication at the web site maintained by the monitoring service server 32, for example. In either case, a profile of power consumption that is computed as a result of the analysis, is stored in the site power consumption database 40.

Principal steps in a method that permit a power consumer to access a power consumption profile for a respective power consumer site using an Internet-accessible world wide web page, are shown in FIG. 6. In step 180 the power consumer enters a uniform resource locator (URL) associated with the monitoring service server 32, and the monitoring service server's web page is displayed to the power consumer. The monitoring service server's web page prompts the power consumer to logon, and thereby identifies the power consumer site of interest (step 182). If the login fails, as determined in step 184, access to power consumption profiles is denied (step 186), although the power consumer may be returned to the monitoring service server's web page, so that the process returns to step 184.

If the authentication is successful, the power consumer is logged on, and a user page associated with the identified power consumer site is displayed (step 188). The user page provides the power consumer with selections for changing the circuit description table (step 190); reviewing the power consumption profile (step 194); requesting an analysis (step 198) changing control options (step 202); and logging off (step 204).

If the power consumer elects to change the circuit description table, an update circuit description table page is displayed (step 192) that permits the power consumer to add or delete one or more of the appliances and power consuming devices associated with the respective power distribution circuits 12. Once the change to the circuit description table has been made or is aborted the user display page is presented and the method returns to step 188.

If the power consumer elects to review the site's power consumption profile, in step 194, a profile display page is presented to the power consumer (step 196). Preferably the profile display page provides selections for changing a view of the power consumption profile, changing the displayed circuits, period of interest, displaying aggregate power consumption profiles, comparing statistics with those of previous years, etc. Once the power consumer has finished reviewing the power consumption profile, the user display page is displayed, and the process returns to step 188.

If the power consumer selects a request analysis option (in step 198), the request is processed by corresponding program instructions at the monitoring service server 32. Processing the request may involve permitting the power consumer to select a plurality of options relating to the requested analysis. The analysis may be performed immediately, or may require substantial processing time, in which case the report of the analysis may be provided in any one of a number of ways, including electronic-mail notification, printed reports, and publication at the user display page. Once the analysis has been requested, the user page is returned and the process returns to step 188.

If the consumer wishes to change how a power consuming device is being controlled, the power consumer may select a change control option on the monitoring unit, a change control option is selected (in step 202), and the monitoring service server 32 registers the changes (step 206), so that commands sent to an identified power consuming device, are changed. If the changes require new control equipment to be installed at the power consumer site, or equipment to be removed (as determined in step 208), a service call is dispatched (step 210), and in either case the process returns to step 188. If the power consumer logs off, the power consumer exits the monitoring service web site, and the process ends.

FIG. 7 schematically illustrates an exemplary per-circuit itemized bill 250 in accordance with the present invention. Each of the power distribution circuits 12 listed in a circuit description table associated with the power consumer site 10 is identified in a bar chart 252, for example. The fraction of the power consumed by the respective power distribution circuit during the identified billing period is presented in a respective bar 254 (only two identified). A legend 256 is provided to indicate content associated with types of the secondary bars in the bar chart 252. Specifically, per-circuit consumption during the current billing period is easily compared with that of a previous billing period, and with a mean of equivalent power distribution circuits of similar power consumer sites. The power consumer can therefore understand which appliances, and circuits are consuming more power than comparable appliances and circuits at other power consumer sites, and a change in consumption since a previous billing period. In alternative embodiments other associated bars may be provided, for example, for comparing with a previous year's equivalent billing period.

As will be understood by those skilled in the art, FIG. 7 illustrates one of many ways in which an itemized electric bill can be formatted to provide information that is valuable to the power consumer. For example, the itemized bill can be presented in a simple table format, in which the description of each monitored power distribution circuit is displayed on one or more lines and consumption data, whether current, comparative, or historical is displayed in a numerical format. Alternatively, the itemized bill may display only total consumption and any anomalies or conditions that are considered to warrant the attention of the power consumer. It is also preferable that consumers be permitted to select the itemized bill format they prefer from among available templates to provide customized itemized billing.

The invention has therefore been described including a method, apparatus and system for monitoring power consumption on a per-circuit basis and providing the power consumption information for analysis at a centralized data storage and analysis server. Although the invention has been described with reference to single-phase residential applications, it should be understood that the invention is not limited to those applications and can also be used to monitor 3-phase commercial applications with equal results.

The embodiments of the invention described above are intended to be exemplary only. The scope of the invention is therefore intended to be limited solely by the scope of the appended claims.

1. A method for providing a power monitoring service, comprising:
providing a monitoring unit at a power consumer site with connections to probes on individual power distribution circuits emanating from a power distribution and control panel of the consumer site;
providing an identification of at least one electrical load on each power distribution circuit in a circuit description table;
measuring a power consumption of each of the power distribution circuits using the corresponding probes;
communicating power consumption data related to the respective power distribution circuits to a power monitoring server that collects the power consumption data; and
analyzing the power consumption data to provide useful information to interested parties.

2. The method as claimed in claim 1 wherein the interested parties comprise any one of the power consumer, a power utility, a power producer, a power analyst, a power broker and a government agency.

3. The method as claimed in claim 2 further comprising providing a world wide web interface to permit the interested parties to access the power consumption information in accordance with a subscription agreement between the power monitoring service and the interested party.

4. The method as claimed in claim 1 wherein communicating power consumption data comprises:
storing a measured power consumption of each of the power distribution circuits accumulated during a measurement interval phase; and
transmitting the stored power consumption data to the power monitor server during a data transmission phase.

5. The method as claimed in claim 1 wherein the step of analyzing further comprises using the power consumption information to compute a power consumption profile of the power consumer site.

6. The method as claimed in claim 1 further comprising using the power consumption information and the circuit description table associated with the power consumption sites, to compute an aggregate power consumption profile of at least one appliance.

7. The method as claimed in claim 6 further comprising comparing the power consumption information of the appliance and a power distribution circuit with the aggregate power consumption profile in order to identify actual power consumption differences between the appliance and a mean of power consumption of similar monitored appliances.

8. The method as claimed in claim 6 further comprising using the information related to power consumption of one appliance over an interval of time, and the aggregate power consumption profile associated with the appliance, to identify a fault in the appliance.

9. The method as claimed in claim 1 further comprising providing the information related to power consumption of the power distribution circuits over an interval of time to a power utility so that the power utility may issue a per-circuit itemized bill to the electrical power consumer.

10. The method as claimed in claim 1 further comprising using the information related to power consumption of the power distribution circuits of a plurality of the power consumer sites, to permit the power utility company that provides electricity to the consumer site, to perform prospective studies.

11. A system for monitoring power consumption information relating to individual power distribution circuits of a consumer site, comprising:
a plurality of probes connected to respective ones of the power distribution circuits, each power distribution circuit being associated with a corresponding circuit description table that identifies at least one electrical load on the power distribution circuit;
a monitoring unit connected to the probes, the monitoring unit including at least one processor for receiving power consumption information measured by the probes, a memory for storing the power consumption information, and a communications link for transmitting the power consumption information to a communications network; and
monitoring service equipment connected to the communications network for receiving the power consumption information, analyzing the power consumption information and making the analyzed power consumption information available to interested parties.

12. The system as claimed in claim 11 wherein each of the plurality of probes is a current probe.

13. The system as claimed in claim 12 wherein each of the at least one processor comprises a digital signal processor (DSP) for sampling the measured power consumption parameter values output by the current probes.

14. The system as claimed in claim 13 wherein each DSP samples each of a plurality of the probes in a cycle, so that a number of DSPs required is less than the number of power distribution circuits.

15. The system as claimed in claim 11 wherein the monitoring unit further comprises an interface for transmitting commands to a controller of at least one power consuming device, the interface and controller permitting the control of the device.

16. A system for monitoring power consumption information relating to individual power distribution circuits of a power consumer site, comprising:
a plurality of probes connected to respective ones of the power distribution circuits, each power distribution circuit being associated with a corresponding circuit description table that identifies at least one electrical load on the power distribution circuit;
a monitoring unit connected to the probes, the monitoring unit including at least one processor for receiving power consumption parameter values measured by the probes, a memory for storing the samples, and a communications link for communicating power consumption information to a remote centralized monitoring service; and
a monitoring service server adapted to receive and store the power consumption information, and analyze the power consumption information to compute a power consumption profile of the individual power distribution circuits.

17. A system as claimed in claim 16 wherein the monitoring service server performs an analysis of power consumption at the power consumer site using the power consumption profile.

18. The system as claimed in claim 17 wherein the monitoring service server comprises a database for storing an aggregate power consumption profile computed using power consumption profiles and circuit description tables of other power consumers.

19. The system as claimed in claim 16 wherein the monitoring service server further comprises a world wide web site for selectively displaying the power consumption profiles and aggregate power consumption profiles.

20. The system as claimed in claim 16 wherein the monitoring service monitors consumption information to detect anomalies respecting the power consumption of appliances connected to the monitored power distribution circuits.

21. The system as claimed in claim 16 wherein the monitoring unit further comprises an interface for transmitting commands from the monitoring service server to a controller of at least one power consumer site device, the interface and controller permitting the monitoring service server to instruct the controller to effect control of the device.
